(19) United States
(12) Patent Application Publication
(10) Pub. No.: US 2018/0273755 A1
(43) Pub. Date: Sep. 27, 2018

(54) LIGNIN COMPOSITIONS

(71) Applicant: E I DU PONT DE NEMOURS AND COMPANY, Wilmington (DE)

(72) Inventors: Michael W. Cobb, Wilmington, DE (US); Hari Babu Sunkara, Hockessin, DE (US); Sharlene Renee Williams, Cincinnati, OH (US)

(21) Appl. No.: 15/523,553

(22) PCT Filed: Nov. 10, 2015
(86) PCT No.: PCT/US15/59905

§ 371 Date: May 1, 2017

Related U.S. Application Data
(60) Provisional application No. 62/078,498, filed on Nov. 12, 2014.

(51) Int. Cl. C08L 97/00; C08L 61/06; C08J 9/00; C08J 9/14; B32B 5/18

(52) U.S. Cl. CPC C08L 97/005; B32B 2607/00; C08J 9/0061; C08J 9/141; C08J 9/145; C08J 9/149; C08J 9/0033; B32B 5/18; C08J 2203/14; C08J 2203/142; C08J 2203/182; C08J 2205/10; C08J 2361/06; C08J 2397/00; C08J 2461/06; C08J 2497/00; B32B 2250/40; B32B 2305/022; B32B 2266/02; B32B 2266/06; B32B 2266/08; B32B 2307/304; B32B 2419/00; C08L 61/06

(57) ABSTRACT

Disclosed herein are lignin-furfuryl alcohol compositions, lignin-furfuryl alcohol-resole (LFR) compositions comprising lignin-furfuryl alcohol composition and phenolic resoles and LFR foams derived from such LFR compositions. Disclosed herein are LFR foams comprising a polymeric phase defining a plurality of open cells and a plurality of closed cells, and a gas phase comprising one or more blowing agents disposed in at least a portion of the plurality of closed cells, wherein the polymeric phase is derived from LFR compositions.

This application claims benefit under 35 U.S.C. § 119(e) of U.S. Provisional Patent Application No. 62/078,498 filed on Nov. 12, 2014, which is herein incorporated by reference.

### FIELD OF THE INVENTION

This disclosure relates in general to, lignin-furfuryl alcohol compositions, lignin-furfuryl alcohol-resole (LFR) compositions comprising lignin-furfuryl alcohol composition and phenolic resoles and LFR foams derived from such LFR compositions.

### BACKGROUND INFORMATION

Plastic foams made of organic polymers continue to grow globally at a rapid pace and these foams are in general classified as rigid, semi-rigid (semi-flexible) and flexible foams. The rigid foams are commercial materials of increasing interest. The critical to quality requirements for rigid foam varies and depends on their end use. For example, thermal insulation rigid foams for construction industry should meet the following requirements: low λ value or high R value, long term stable insulation performance, high closed-cell content, low density, low friability, low corrosion, low water absorption and breathability, good strength, high fire and chemical resistance. In contrast, the requirements are different for rigid foams for floral or agricultural foams that include open-cell structure, high friability, low strength, high water absorption, high breathability and ultra-low density.

Phenol-formaldehyde (PF) rigid foams represent one of the many classes of organic polymers available commercially, and are being used in thermal insulation, particularly in roof, wall and floor insulations and also in floral applications. When compared to other closed-cell rigid insulation foams such as polyurethane, polyisocyanurate, extruded and expanded polystyrene foams, the rigid PF foams are superior in terms of high thermal insulation, excellent fire and chemical resistance. However, these foams are relatively expensive, brittle, corrosive, absorb high amount of water and emit toxic formaldehyde which make them unsuitable for broad range of insulation applications. Besides, these PF foams are being prepared from fossil-fuel based ingredients. The rising cost and foreseeable future scarcity of petrochemicals have prompted researchers to evaluate phenolic foams, using natural products from renewable resources.

Lignin is readily available as a by-product from the pulp and paper industry. Because of its renewability, phenol-like structure, low cost, non-toxicity and environmentally friendly nature lignin can be a “greener” substitute to synthetic phenolic resins and foams. However, lignin is a much larger molecule, has few reactive sites for formaldehyde, more hydrophobic and insoluble in aqueous system, as compared to other natural polyphenols, such as condensed tannin. The low reactivity of lignin results in insufficient cross-linking of lignin that accounts for poor performance. Several attempts have also been made to improve lignin's reactivity by modification and/or depolymerization of lignin molecules. However, most current methods of modification of lignin are not economically attractive.

Hence, there is a need for a new lignin composition and process for making partially substituted phenol-formaldehyde foams with lignin.

### SUMMARY OF THE INVENTION

In a first embodiment, there is a lignin-furfuryl alcohol-resole (LFR) composition comprising:
(i) 10-90 wt % of a lignin-furfuryl alcohol composition derived from a lignin, water, and one or more lignin reactive monomers, wherein at least one of the one or more lignin reactive monomers is furfuryl alcohol;
(ii) 10-90 wt % of a phenolic-resole derived from a phenol and a phenol-reactive monomer; and
(iii) optionally 0.1-10 wt % of an organic amine comprising urea, melamine, hexamine, or mixtures thereof,
   wherein the amounts in wt % are based on the total weight of the LFR composition.

In a second embodiment of the LFR composition, the phenol-reactive monomer comprises at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof.

In a third embodiment of the LFR composition, the phenol-reactive monomer is formaldehyde.

In a fourth embodiment, the LFR composition further comprises at least one of an organic anhydride, a surfactant, and a plasticizer.

In a fifth embodiment, a thermoset polymer derived from the LFR composition, as disclosed hereinabove.

In a sixth embodiment, a thermoset polymer is derived from the LFR composition as disclosed hereinabove and at least one of urea-formaldehyde resin, melamine-formaldehyde resin and resorcinol-formaldehyde resin.

In a seventh embodiment, there is a lignin-furfuryl alcohol-resole (LFR) foam comprising:
(i) a polymeric phase defining a plurality of open cells and a plurality of closed cells, and
(ii) a gas phase comprising one or more blowing agents disposed in at least a portion of the plurality of closed cells,
wherein the polymeric phase is derived from:
   a) a lignin-furfuryl alcohol composition derived from a lignin, water, and one or more lignin reactive monomers, wherein at least one of the one or more lignin reactive monomers is furfuryl alcohol, and
   b) a phenol-formaldehyde resole.

In an eighth embodiment of the LFR foam, at least one of the one or more blowing agents comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.

In a ninth embodiment of the LFR foam, at least one of the one or more blowing agents comprises an azeotrope or an azeotrope-like mixture of isopentane and one other blowing agent selected from the group consisting of isopropyl chloride, 1,1,1,4,4,4-hexafluoro-2-butene and 1-chloro-3,3,3,-trifluoropropene.

In a tenth embodiment of the LFR foam, the blowing agent comprises a mixture of isopropyl chloride and isopentane.

In an eleventh embodiment, there is an article comprising the LFR foam.

In a twelfth embodiment, the article comprises a sandwich panel structure, wherein the sandwich panel structure comprises the LFR foam disposed between two similar or dissimilar non-foam materials.

In a thirteenth embodiment, a foam is formed by foaming and curing a composition at a temperature in the range of 50-100° C., the composition comprising
a. a lignin-furfuryl alcohol composition derived from a lignin, water, and one or more lignin reactive monomers, wherein at least one of the one or more lignin reactive monomers is furfuryl alcohol,
b. a phenolic-resole,
c. a blowing agent,
d. an acid catalyst, and
e. a surfactant.

In a fourteenth embodiment, there is a method of making a lignin-furfuryl alcohol-resole (LFR) foam comprising:
a) forming a lignin-furfuryl alcohol composition from a lignin, water, and one or more lignin reactive monomers, wherein at least one of the one or more lignin reactive monomers is furfuryl alcohol;
b) adding a phenolic-resole to the lignin-furfuryl alcohol composition of step (a) to form a lignin-furfuryl alcohol-resole (LFR) composition, wherein the phenolic-resole is derived from a phenol and a phenol-reactive monomer comprising at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof;
c) adding at least one blowing agent to the LFR composition of step (b);
d) adding an aromatic sulfonic acid to the LFR composition of step (b) or (c) to form a foamable-LFR composition;
e) adding a surfactant to at least one of the steps (a), (b), (c) or (d); and
f) foaming and curing the foamable-LFR composition at a temperature in the range of 50-100° C. to form a foam comprising a polymeric phase defining a plurality of open cells and a plurality of closed cells,
   wherein the polymeric phase is derived from the lignin-furfuryl alcohol-resole (LFR) composition.

In a fifteenth embodiment of the method, the aromatic sulfonic acid comprises para-toluenesulphonic acid and xylenesulphonic acid.

In a sixteenth embodiment of the method, the at least one blowing agent comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.

In a seventeenth embodiment, the method further comprises disposing the foam between two similar or dissimilar non-foam materials to form a sandwich panel structure.

### DETAILED DESCRIPTION

Disclosed herein are lignin-furfuryl alcohol compositions, lignin-furfuryl alcohol-resole (LFR) compositions comprising lignin-furfuryl alcohol composition and phenolic resoles and LFR foams derived from such LFR compositions.

As used herein, the term “biologically-derived” is used interchangeably with “bio-derived” and refers to chemical compounds including monomers and polymers, that are obtained from plants and contain renewable carbon.

As used herein, the term “bio-based lignin composition” refers to compositions that contains at least 25% renewable carbon, and less than 75% fossil fuel based or petroleum based carbon.

As used herein, the term “bio-based foam” is used interchangeably with “bio-based closed-cell foam” and “bio-based open-cell foam” and refers to foams that are derived from at least one monomer of the resin that is obtained from plants and contains at least 25% renewable carbon, and less than 75% fossil fuel based or petroleum based carbon.

The terms “percent by weight”, “weight percentage (wt %)” and “weight-weight percentage (% w/w)” are used interchangeably herein. Percent by weight refers to the percentage of a material on a mass basis as it is comprised in a composition, mixture or solution.

Lignin-Furfuryl Alcohol Composition

In an aspect, there is a lignin-furfuryl alcohol composition comprising a lignin, water, one or more lignin reactive monomers, wherein at least one of the one or more lignin reactive monomers is furfuryl alcohol, and oligomers of furfuryl alcohol. The lignin-furfuryl alcohol composition has a viscosity in the range of about 6000 to about 250000 cP at 25° C. In another embodiment, lignin-furfuryl alcohol composition further comprises a surfactant.

Any suitable hard wood lignin or soft wood lignin may be used in the lignin-furfuryl alcohol composition, including but not limited to, Kraft lignin and lignosulfonate. Modified lignin may also be useful in the preparation of lignin-furfuryl alcohol composition, though they are relatively more expensive than the unmodified lignin and thus may be economically unattractive. The lignin is present in the lignin-furfuryl alcohol composition in an amount ranging from about 25 wt % to about 80 wt %, or from about 30 wt % to about 75 wt %, or from about 35 wt % to about 70 wt %, based on the total weight of the lignin-furfuryl alcohol composition.

Suitable lignin reactive monomers include, but are not limited to furfuryl alcohol, furfural, 5-hydroxymethylfurfural, 2,5-furandicarboxylic aldehyde, and mixtures thereof. In an embodiment, the one or more lignin reactive monomers are bio-derived. For example, bio-derived furfuryl alcohol can be obtained by catalytic reduction of furfural with hydrogen, wherein furfural is obtained by acid hydrolysis of sugars and waste from agricultural processes. The one or more lignin reactive monomers are present in the lignin-furfuryl alcohol composition in an amount ranging from about 20 wt % to about 60 wt %, or from about 25 wt % to about 50 wt %, or from about 30 wt % to about 40 wt %, by weight, based on the total weight of the lignin-furfuryl alcohol composition.

The lignin-furfuryl alcohol composition also comprises water present in an amount ranging from about 0.1 wt % to about 15 wt %, or from about 1 wt % to about 12 wt %, or from about 2 wt % to about 10 wt %, based on the total weight of the lignin-furfuryl alcohol composition.

The lignin-furfuryl alcohol composition may comprise oligomers of furfuryl alcohol, as shown below in scheme-1, in any suitable amount. The molecular weight and amount of oligomers of furfuryl alcohol is dependent upon the temperature at which lignin-furfuryl alcohol composition is heated, the amount of heating time and the acidity of lignin-furfuryl alcohol composition, which in turn affects the viscosity of the lignin-furfuryl alcohol composition.

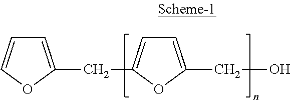

The viscosity of the lignin-furfuryl alcohol composition can be adjusted with the addition of surfactant.

In an embodiment, the lignin-furfuryl alcohol composition comprises lignin, water, furfuryl alcohol and oligomers of furfuryl alcohol. In another embodiment, the lignin-furfuryl alcohol composition comprises lignin, water, furfuryl alcohol, oligomers of furfuryl alcohol and one or more lignin reactive monomers comprising furfural, 5-hydroxymethylfurfural, 2,5-furandicarboxylic aldehyde, or mixtures thereof.

In another embodiment, the lignin-furfuryl alcohol composition comprises lignin, water, one or more lignin reactive monomers, oligomers of furfuryl alcohol and a surfactant, wherein at least one of the one or more lignin reactive monomers is furfuryl alcohol. The lignin-furfuryl alcohol composition may further comprise oligomers of furfuryl alcohol and lignin.

Any suitable surfactant may be used in the lignin-furfuryl alcohol composition, including, but not limited to non-ionic surfactants, such as the condensation products of alkylene oxides such as ethylene oxide, propylene oxide or mixtures thereof, and alkylphenols such as nonylphenol, dodecylphenol, and the like. Suitable non-ionic surfactants include, but are not limited to, polyether-modified polysiloxanes, available as Tegostab B8406 from Evonik Goldschmidt Corporation (Hopewell, Va.), ethoxylated castor oil, available as Lumulse CO-30 from Lambent Technologies; polysorbate (Tween®) surfactant, for example Tween® 40 available from Aldrich Chemical Company; Pluronic® non-ionic surfactants available from BASF Corp., (Florham Park, N.J.); Tergitol™; Brij® 98, Brij® 30, and Triton X 100, all available from Aldrich Chemical Company. The surfactant may be present in the lignin-furfuryl alcohol composition in an amount ranging from about 0.01 wt % to about 10 wt %, or from about 1 wt % to about 8 wt %, or from about 3 wt % to about 6 wt %, based on the total weight of the lignin-furfuryl alcohol composition.

In an embodiment, the lignin-furfuryl alcohol composition of the present disclosure is essentially free from formaldehyde and other polyphenols such as condensed or hydrolyzed tannin.

A homogenous lignin-furfuryl alcohol composition can be prepared by adding lignin to furfuryl alcohol and water mixture in the presence or absence of a surfactant and heating the solution at a temperature in the range of about 25° C. to about 80° C., or about 30° C. to about 75° C., or about 35° C. to about 70° C. for an amount of time in the range of about 0.1 to about 10.0 hours or about 1 hour to about 6 hours or 2 hours to about 5 hours to obtain a viscous lignin-furfuryl alcohol composition having a viscosity in the range of about 6000 cP to about 250000 cP, or about 7000 cP to about 150000 cP, or about 8000 cP to about 100000 cP at 25° C. The viscosity of the lignin-furfuryl alcohol composition can be controlled by heating the lignin-furfuryl alcohol composition due to oligomerization of furfuryl alcohol and reaction between furfuryl alcohol and lignin molecules and also by the addition of surfactant.

Lignin-Furfuryl Alcohol-Resole (LFR) Composition

In an aspect of the present disclosure, there is a lignin-furfuryl alcohol-resole (LFR) composition comprising the lignin-furfuryl alcohol composition as disclosed hereinabove, and a phenolic-resole derived from a phenol and a phenol-reactive monomer.

As used herein, the term “phenol-reactive monomer” refers to any monomer that reacts with nucleophilic sites of the phenol. Suitable phenol-reactive monomers include, but are not limited to formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof. In an embodiment, the phenol-reactive monomer is formaldehyde.

As used herein, the term “phenolic-resole” refers to a polycondensation product of a phenol and a phenol-reactive monomer. The scheme 2 as shown below shows a phenolic resole obtained by polycondensation of phenol and a phenol reactive monomer such as formaldehyde, the phenolic resole comprising reactive methylol groups (CH₂OH):

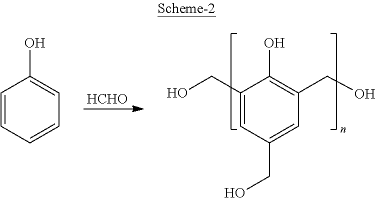

The phenolic-resoles can be prepared with a molar fraction of phenol-reactive monomer to phenol>1 in the presence of a basic catalyst. Any suitable substituted phenol or unsubstituted phenol may be used to prepare the phenolic-resole of the present disclosure. As used herein, the term “substituted phenol” refers to a molecule containing a phenolic reactive site and can contain another substituent group or moiety. Exemplary substituted phenols include, but are not limited to, ethyl phenol; p-tertbutyl phenol; ortho, meta, and para cresol; resorcinol; catechol; xylenol; and the like. In an embodiment, the phenolic resoles are derived from an unsubstituted phenol and a phenol-reactive monomer.

In an embodiment, the phenolic-resole is derived from a phenol and formaldehyde. In another embodiment, the phenolic-resole is derived from a phenol, urea, and formaldehyde.

In one embodiment, the phenolic-resole has a number average molecular weight of less than about 1500 or less than about 1000 and has a viscosity of less than about 30,000 cP or less than about 20,000 cP at 25° C.

In an embodiment of the LFR composition as disclosed hereinabove, the amount of lignin-furfuryl alcohol composition is in the range of about 10 wt % to about 90 wt %, or about 20 wt % to about 80 wt %, or about 30 wt % to about 75 wt %, wherein the amounts in wt % are based on the total weight of the LFR composition.

In another embodiment of the LFR composition, the amount of the phenolic-resole is in the range of about 10 wt % to about 90 wt %, or about 20 wt % to about 80 wt %, or about 25 wt % to about 70 wt %, wherein the amounts in wt % are based on the total weight of the LFR composition.

In an embodiment, the LFR composition further comprises about 0.1 wt % to about 10 wt %, or about 1 wt % to about 8 wt %, or about 2 wt % to about 6 wt % of an organic amine, wherein the amounts in wt % are based on the total weight of the LFR composition. Any suitable organic amine may be used, including, but not limited to urea, melamine, hexamine or mixtures thereof.

In an embodiment, the LFR composition further comprises at least one of an organic anhydride, a surfactant, a plasticizer or an aromatic sulfonic acid.

Suitable organic anhydrides include, but are not limited to maleic anhydride, acetic anhydride, succinic anhydride, phthalic anhydride and trimelletic anhydride. In an embodiment, the organic anhydride used in the LFR composition is maleic anhydride.

Suitable plasticizers include, but are not limited to a polyether polyol such as polyethylene glycol or polypropylene glycol or a polyester polyol, formed by the reaction of a polybasic carboxylic acid with a polyhydridic alcohol selected from a dihydridic to a pentahydridic. Examples of the acid include but are not limited to adipic acid, sebacic acid, naphthalene-2,6-dicarboxylic acid, cyclohexane-1,3-dicarboxylic acid, phthalic acid. Examples of the polyhydric alcohol include but are not limited to ethylene glycol, propylene diol, propylene glycol, 1,6-hexane diol, 1,4-butane diol and 1,5-pentane diol. In an embodiment, the plasticizer is polyester polyol. The average molecular weight is in the range of 100-50,000 g/mol, or 200-40,000 g/mol, or 200-1000 g/mol.

In an aspect, there is a process to make LFR composition of the present disclosure comprising three steps:
(i) forming a lignin-furfuryl alcohol composition, as disclosed hereinabove;
(ii) providing a phenolic-resole obtained by reacting a phenol with a phenol reactive monomer under alkaline conditions at a temperature in the range of about 70° C. to about 90° C. for sufficient time to obtain a phenolic-resole having a number average molecular weight of less than about 1500; and
(iii) mixing the lignin-furfuryl alcohol composition of step (i) with the phenolic-resole of step (ii) at room temperature to obtain a LFR composition having viscosity in the range from about 5,000 cP to about 150,000 cP at 25° C.

The LFR compositions of the present disclosure further comprises at least one of urea-formaldehyde, melamine-formaldehyde or resorcinol-formaldehyde binders.

In an aspect, there is a resin derived from the lignin-furfuryl alcohol compositions as disclosed hereinabove and at least one of urea-formaldehyde resin, melamine-formaldehyde resin and resorcinol-formaldehyde resin.

The LFR compositions of the present disclosure are useful in preparing thermoset resins as binders in foundry and adhesive formulations and also in preparing thermoset foams and composites for construction, packaging, and transport industries. There are several advantages of these resins and foams derived from the LFR compositions of the present disclosure, including, but not limited to having ingredients from renewable sources, low amount or substantially free of phenol and formaldehyde, and less odor as compared to phenol-formaldehyde resin. In an embodiment, the LFR compositions as disclosed hereinabove can be used in preparing an adhesive composition for bonding veneer sheets to make plywood or other laminated wood products together, for laminating wood veneers, or for bonding wood chips together to produce particleboard.

Foamable-LFR Compositions & LFR Foams

In an aspect, there is a foamable-LFR composition comprising the LFR composition as disclosed hereinabove, a blowing (foam expansion) agent, an acid catalyst and a surfactant.

In an embodiment, a thermoset foam can be prepared by foaming and curing a foamable-LFR composition of the present disclosure at a temperature in the range of about 50° C. to about 100° C. While not bound by any specific theory, it is believed that, in the presence of an acid catalyst in the foamable composition, the furfuryl alcohol present in the foamable composition from the lignin-furfuryl alcohol composition, not only polymerizes by itself forming oligomers as shown in Scheme-2 and releases heat to boil off the blowing agent, but also co-reacts with the phenolic-resole and lignin molecules as shown in the Scheme-3 below to form a thermoset lignin-furfuryl alcohol-resole (LFR) copolymer.

Furthermore, in the presence of an acid catalyst, the reactive methylol groups of the phenolic resole can react with other methylol groups of the phenolic resole or with lignin and/or furfuryl alcohol or with the oligomers of furfuryl alcohol shown above in Scheme-2 or with derivatives of lignin and furfuryl alcohol to form a thermoset resin. Scheme-3, as shown below, shows one of the many possible reactions between the reactive methylol groups of phenolic resole, lignin, oligomer of furfuryl alcohol that may occur in the formation of a thermoset resin & or foam comprising the lignin-furfuryl alcohol-resole (LFR) copolymer.

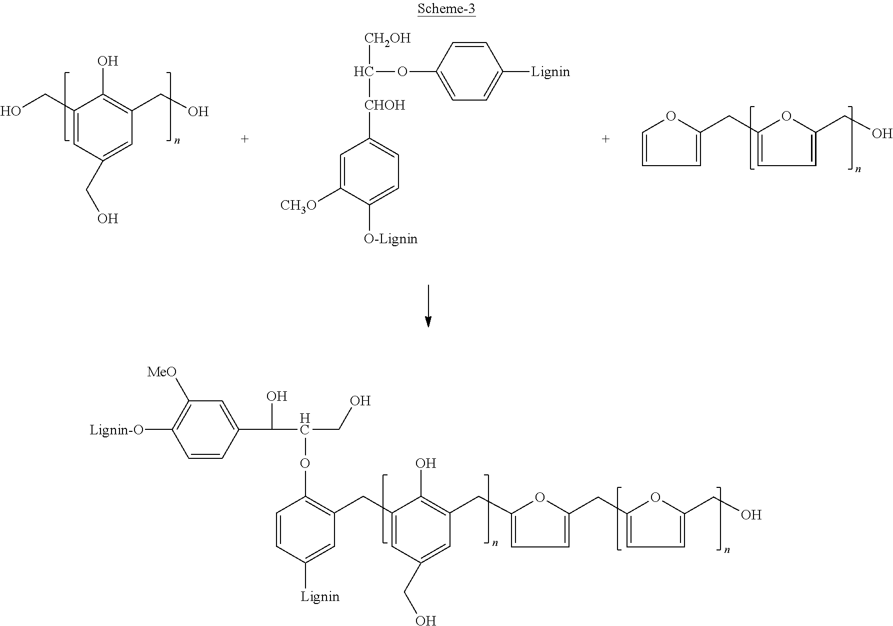

In an aspect, the LFR foam derived from the foamable-LFR composition comprises a polymeric phase defining a plurality of open cells and a plurality of closed cells, and a gas phase comprising one or more blowing agents disposed in at least a portion of the plurality of closed cells, wherein the polymeric phase is derived from a lignin-furfuryl alcohol composition as disclosed hereinabove and a phenolic resole.

As used herein, the term “open-cell” refers to individual cells that are ruptured or open or interconnected producing a porous “sponge” foam, where the gas phase can move around from cell to cell. As used herein, the term “closed-cell” refers to individual cells that are discrete, i.e. each closed-cell is enclosed by polymeric sidewalls that minimize the flow of a gas phase from cell to cell. It should be noted that the gas phase may be dissolved in the polymer phase besides being trapped inside the closed-cell. Furthermore, the gas composition of the closed-cell foam at the moment of manufacture does not necessarily correspond to the equilibrium gas composition after aging or sustained use. Thus, the gas in closed-cell foam frequently exhibits compositional changes as the foam ages leading to such known phenomenon as increase in thermal conductivity or loss of insulation value. Since the surfactant in the foamable composition controls the cell size as well as the ratio of open-to-closed cell units, LFR foam with open or closed-cell can be obtained by adjusting the amount of surfactant level in the foamable composition.

In one embodiment, the LFR foam of the present disclosure has an open-cell content of less than about 20% (or closed-cell content greater than about 80%), or less than about 15%, or less than about 10%, as measured according to ASTM D6226-5 for use as thermal insulation foams. In another embodiment, the foam has an open-cell content of more than 20%, or more than 50%, or more than 70%, or more than 80% for use as cushion/acoustic foams, vacuum insulation panel (VIP), and floral applications.

In an embodiment, the foams of the present disclosure are used in construction, packaging and transportation industrial applications.

In an embodiment, the LFR foam of the present disclosure is a bio-based foam.

In one embodiment, the LFR foam is bio-based with the total bio-derived content in the range of about 10 wt % to about 95 wt %, or about 15 wt % to about 80 wt % or about 20 wt % to about 60 wt %, or about 25 wt % to about 50 wt % by weight with respect to the total weight of the LFR foam, excluding the amount of blowing agent.

In one embodiment, the bio-based foam is derived from a lignin dissolved in water and a lignin reactive monomer and optionally an organic amine.

In another embodiment, the LFR foam is derived from a formaldehyde-free composition comprising a lignin, furfuryl alcohol, water, maleic anhydride, urea, a surfactant, blowing agent, an aromatic sulfonic acid, plasticizer or mixtures thereof. In an embodiment, the formaldehyde-free composition further comprises maleic anhydride, urea, plasticizer, or mixtures thereof.

In an embodiment, the LFR foam is derived from a foamable-LFR composition comprising the LFR composition of the present disclosure, a blowing agent, an acid catalyst and a surfactant, wherein the LFR composition comprises a lignin-furfuryl alcohol composition, a phenolic-resole, urea, and surfactant. In another embodiment, the LFR composition further comprises organic anhydride, plasticizer, or mixtures thereof.

In another embodiment, the LFR foam is derived from a foamable-LFR composition comprising the LFR composition of the present disclosure, a blowing agent, an acid catalyst and a surfactant, wherein the LFR composition comprises a lignin-furfuryl alcohol composition, a phenolic-resole, urea, surfactant, and at least one of maleic anhydride, plasticizer or mixtures thereof.

As used herein, the term “blowing agent” is used interchangeably with the term “foam expansion agent”. In general, the blowing agent must be volatile and inert, and can be inorganic or organic. In an embodiment, the blowing agent present in the LFR foam comprises hydrocarbons such as pentane, isopentane, cyclopentane, petroleum ether, and ether; hydrochlorofluorocarbons such as 1,1-dichloro-1-fluoroethane (HCFC-141b); 2,2-dichloro-1,1,1-trifluoroethane (HCFC-123); 1-chloro-1,1-difluoroethane (HCFC-142b); 1,1,1,2-tetrafluoroethane (HCFC-134a); 1,1,1,3,3-pentafluoropropane (HFC-245fa); 1,1,1,3,3-pentafluorobutane (HFC-365); incompletely halogenated hydrocarbons such as 2-chloropropane (isopropyl chloride); fluorocarbons such as dichlorodifluoromethane, 1,2-dichloro-1,1,2,2-tetrafluoroethane (CFC-114), trichlorotrifluoroethane (CFC-113), trichloromonofluoromethane (CFC-11), or mixtures thereof. In another embodiment, the blowing agent comprises an azeotrope or an azeotrope-like mixture of isopentane and one other blowing agent selected from the group consisting of isopropyl chloride, 1,1,1,4,4,4-hexafluoro-2-butene and 1-chloro-3,3,3,-trifluoropropene. In an embodiment, the blowing agent comprises a mixture of isopropyl chloride and isopentane.

As used herein, the term “azeotrope-like” is intended in its broad sense to include both compositions that are strictly azeotropic and compositions that behave like azeotropic mixtures. From fundamental principles, the thermodynamic state of a fluid is defined by pressure, temperature, liquid composition, and vapor composition. An azeotropic mixture is a system of two or more components in which the liquid composition and vapor composition are equal at the stated pressure and temperature. In practice, this means that the components of an azeotropic mixture are constant boiling and cannot be separated during a phase change.

The azeotrope-like compositions of the present disclosure may include additional components that do not form new azeotrope-like systems, or additional components that are not in the first distillation cut. The first distillation cut is the first cut taken after the distillation column displays steady state operation under total reflux conditions. One way to determine whether the addition of a component forms a new azeotrope-like system so as to be outside of this disclosure is to distill a sample of the composition with the component under conditions that would be expected to separate a non-azeotropic mixture into its separate components. If the mixture containing the additional component is non-azeotrope-like, the additional component will fractionate from the azeotrope-like components. If the mixture is azeotrope-like, some finite amount of a first distillation cut will be obtained that contains all of the mixture components that is constant boiling or behaves as a single substance.

It follows from this that another characteristic of azeotrope-like compositions is that there is a range of compositions containing the same components in varying proportions that are azeotrope-like or constant boiling. All such compositions are intended to be covered by the terms “azeotrope-like” and “constant boiling”. As an example, it is well known that at differing pressures, the composition of a given azeotrope will vary at least slightly, as does the boiling point of the composition. Thus, an azeotrope of A and B represents a unique type of relationship, but with a variable composition depending on temperature and/or pressure. It follows that, for azeotrope-like compositions, there is a range of compositions containing the same components in varying proportions that are azeotrope-like. All such compositions are intended to be covered by the term azeotrope-like as used herein.

As used herein, ozone depletion potential (ODP) of a chemical compound is the relative amount of degradation to the ozone layer it can cause, with trichlorofluoromethane (CFC-11) being fixed at an ODP of 1.0. As used herein, the global-warming potential (GWP) used herein is a relative measure of how much heat a greenhouse gas traps in the atmosphere. It compares the amount of heat trapped by a certain mass of the gas in question to the amount heat trapped by a similar mass of carbon dioxide, which is fixed at 1 for all time horizons (20 years, 100 years, and 500 years). For example, CFC-11 has GWP (100 years) of 4750. Hence, from the global warming perspective, a blowing agent should have zero ODP and as low GWP as possible.

In some embodiments, at least one or more blowing agents has an ozone depletion potential (ODP) of less than 2, or less than 1 or 0. In other embodiments, at least one of the one or more blowing agents has a global warming potential (GWP) of less than 5000, or less than 1000, or less than 500. An exemplary blowing agent with zero ODP and a low GWP is a mixture of isopentane and isopropyl chloride (ODP of 0 and GWP of less than 20).

In another embodiment, the LFR foam of the present disclosure is a rigid cross-linked foam for use as a thermal insulation foam, having a thermal conductivity of less than about 28 mW/m K, or about 27 mW/mK, or about 26 mW/mK, measured at 25° C.

In an embodiment, the LFR foam has an apparent density in the range of about 10 kg/m³ to about 50 kg/m³, or 20 kg/m³ to about 45 kg/m³, or about 30 kg/m³ to about 40 kg/m³. The LFR foams can be prepared having an apparent density of greater than 50 kg/m³, but low density foams are preferred.

In an embodiment, the LFR foam has an aged thermal conductivity of less than about 28 mW/m·K, an open-cell content of less than 10% and an apparent density in the range of about 20 kg/m³ to about 45 kg/m³.

The overall thermal conductivity of the foam is strongly determined by the thermal conductivity of the gas phase or the discontinuous phase, the open-cell content of the foam and size and strength of the foam cell. This is because the gas phase or the discontinuous phase disposed in at least a portion of the plurality of the closed-cells in a low-density foam (having a density in the range of about 20 kg/m³ to about 45 kg/m³), usually makes up about 95% of the total foam volume. Hence, only those foams that are blown from low thermal conductivity blowing agents and result in closed cell structures, with significant fraction of the blowing agent trapped within the closed cells, can exhibit low thermal conductivity.

In addition to the closed cell content, the size and strength of the cells in a foam can also affect the resulting thermal conductivity. In addition to thermal properties, the cell size and strength of the foam can also affect other properties of the foam, such as but not limited to the mechanical properties. In general, it is desirable that the cells of the foam be small and uniform. However, the size of the cells cannot be reduced indefinitely because for a given density foam if the cell size becomes too small the thickness of the cell walls can become exceedingly thin and hence can become weak and rupture during the blowing process or during use. Hence, there is an optimum size for the cells depending on the density of the foam and its use. In one embodiment, a cell, a closed-cell, has an average size in the range of 50 microns to 500 microns. Cell size may be measured by different methods known to those skilled in the art of evaluating porous materials. In one method, thin sections of the foam can be cut and subjected to optical or electron microscopic measurement, such as using a Hitachi S2100 Scanning Electron Microscope available from Hitachi instruments (Schaumburg, Ill.).

In an embodiment, the LFR foams of the present teachings are bio-derived, low density rigid foams, having low thermal conductivity and low flammability. The bio-based foams of the present teachings could be used for a variety of applications, including, but not limited to, thermal insulation of building envelopes, household and industrial appliances, transportation and package. Furthermore, the disclosed foams can also be used in combination with other materials such as silica aerogels as a support for the fragile aerogel. Additional advantages of the disclosed foams include, but are not limited to, the use of less toxic materials, zero or low formaldehyde emission, improved flame resistance, mold resistance, enhanced biodegradability, and micro-organism resistance.

Articles Comprising LFR Foams & Uses

In an embodiment, there is an article comprising the LFR foam of the present teachings. In another embodiment, the article comprises a sandwich panel structure, wherein the sandwich panel structure comprises the LFR foam of the present teachings disposed between two similar or dissimilar non-foam materials, also called facers to form a sandwich panel structure. Any suitable material can be used for the facers. In one embodiment, the facers may be formed from a metal such as, but not limited to aluminum and stainless steel. In another embodiment, the facers may be formed from plywood, cardboard, composite board, oriented strand board, gypsum board, fiber glass board, and other building materials known to those skilled in the art. In another embodiment, the facers may be formed from nonwoven materials derived from glass fibers and/or polymeric fibers such as Tyvek® and Typar® available from E. I. DuPont de Nemours & Company. In another embodiment, the facers may be formed from woven materials such as canvas and other fabrics. Yet, in another embodiment, the facers may be formed of polymeric films or sheets. Exemplary polymers for the facer may include, but are not limited to, polyethylene, polypropylene, polyesters, and polyamides.

The thickness of the facer material would vary depending on the application of the sandwich panel. In some cases, the thickness of the facer material could be significantly smaller than the thickness of the foam while in other cases the thickness of the facer material could be comparable or even greater than the thickness of the sandwiched foam.

In some embodiments, the facer material may be physically or chemically bonded to the LFR foam to increase the structural integrity of the sandwich panel. Any suitable method can be used for physical means of bonding including, but not limited to, surface roughening by mechanical means and etching by chemical means. Any suitable method can be used for chemical bonding including, but not limited to, use of coatings, primers, and adhesion promoters that form a tie layer between the facer surface and the foam.

Also disclosed is a bio-based foam formed by foaming and curing a formaldehyde-free composition at a temperature in the range of 50-100° C., the formaldehyde-free composition comprising a lignin, a lignin reactive monomer, water, an organic anhydride, urea, a blowing agent, an acid catalyst, and a surfactant. The as-formed bio-based foam comprising a polymeric phase defining a plurality of cells and a discontinuous phase disposed in at least a portion of the plurality of cells, the discontinuous phase comprising a blowing agent.

Process of Making a LFR Foam

In an aspect, there is a method of making a lignin-furfuryl alcohol-resole (LFR) foam. The process comprises providing a lignin-furfuryl alcohol composition comprising a lignin dissolved in water and one or more lignin reactive monomers, wherein at least one of the one or more lignin reactive monomers is furfuryl alcohol.

The lignin is present in the lignin-furfuryl alcohol composition in an amount ranging from about 25 wt % to about 80 wt %, or from about 30 wt % to about 75 wt %, or from about 35 wt % to about 70 wt %, based on the total weight of the lignin-furfuryl alcohol composition. The amount of the lignin-reactive monomer present in the lignin-furfuryl alcohol composition is in the range of about 20 wt % to about 60 wt %, or from about 25 wt % to about 50 wt %, or from about 30 wt % to about 40 wt %, by weight based on the total weight of the lignin-furfuryl alcohol composition. The lignin-furfuryl alcohol composition also comprises water present in an amount ranging from about 0.1 wt % to about 15 wt %, or from about 1 wt % to about 12 wt %, or from about 2 wt % to about 10 wt %, based on the total weight of the lignin-furfuryl alcohol composition.

The step of providing a lignin-furfuryl alcohol composition comprises forming an agglomerate free homogeneous lignin-furfuryl alcohol composition by mixing a lignin with a lignin-reactive monomer, and water in the presence or absence of a surfactant to form a mixture and providing a residence time to the mixture to effectively dissolve the lignin in the mixture. The viscosity of the lignin-furfuryl alcohol composition can be controlled by heating the lignin-furfuryl alcohol composition at a temperature in the range of about 25° C. to about 80° C., or about 30° C. to about 75° C., or about 35° C. to about 70° C. for an amount of time in the range of about 0.1 to about 10.0 hours or about 1 hour to about 6 hours or 2 hours to about 5 hours. Depending upon the temperature at which lignin-furfuryl alcohol composition is heated and the amount of heating time, the lignin-furfuryl alcohol composition can have a viscosity in the range of about 6000 cP to about 250000 cP, or about 7000 cP to about 150000 cP, or about 8000 cP to about 100000 cP at 25° C. The increase in viscosity of the lignin-furfuryl alcohol composition is due to the oligomerization of furfuryl alcohol and reaction between furfuryl alcohol and lignin molecules.

Any suitable method can be used to mix the lignin with the lignin-reactive monomer, and water, to form an agglomerate-free solution, such as, for example, hand mixing, mechanical mixing using a Kitchen-Aid® mixer, a twin screw extruder, a bra-blender, an overhead stirrer, a ball mill, an attrition mill, a Waring blender, or a combination thereof.

In an embodiment, the step of forming the agglomerate-free lignin-furfuryl alcohol composition comprising a lignin, a lignin-reactive monomer, and water can include first mixing the lignin with water and then adding the lignin reactive monomer to the mixture of lignin and water. In other embodiment, the step of forming an agglomerate-free lignin-furfuryl alcohol composition comprising a lignin, a lignin-reactive monomer, and water can include first mixing the lignin with the monomer and then adding water to the mixture of lignin and monomer. In another embodiment, the step of forming an agglomerate-free lignin-furfuryl alcohol composition comprising a lignin, a lignin-reactive monomer, and water can include first mixing the monomer with water and then adding lignin to the mixture of lignin-reactive monomer and water.

The method further comprises adding about 10 wt % to about 90 wt %, or about 20 wt % to about 80 wt %, or about 25 wt % to about 70 wt %, of a phenolic-resole to the heated lignin-furfuryl alcohol composition to form a lignin-furfuryl alcohol-resole (LFR) composition. In an embodiment, the phenolic-resole is derived from a phenol, a phenol-reactive monomer comprising at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof. In an embodiment, the phenolic-resole is derived from a phenol, a phenol-reactive monomer and an organic amine such as urea, melamine, hexamine or mixtures thereof.

The process further comprises adding a surfactant and at least one blowing agent to the LFR composition, and adding an aromatic sulfonic acid to the LFR mixture to form a foamable-LFR composition.

The amount of blowing agent is in the range of about 0.5 wt % to about 20 wt %, or about 1 wt % to about 15 wt %, or about 1 wt % to about 10 wt %, based on the total weight of the foamable-LFR composition. In an embodiment, the blowing agent comprises an azeotrope or an azeotrope-like mixture of isopentane and one other blowing agent selected from the group consisting of isopropyl chloride, 1,1,1,4,4,4-hexafluoro-2-butene and 1-chloro-3,3,3,-trifluoropropene. In another embodiment, the blowing agent comprises a mixture of isopropyl chloride and isopentane present in a weight ratio of 90:10, or 75:25, or 50:50, or 10:90.

The amount of aromatic sulfonic acid is in the range of about 1 wt % to about 20 wt %, or about 5 wt % to about 15 wt %, or about 5 wt % to about 12 wt %, based on the total weight of the foamable-LFR composition, excluding the weight of blowing agent.

In an embodiment, the acid catalyst comprises para-toluenesulphonic acid and xylenesulphonic acid in a weight ratio in the range of 1:9 to 9:1, or 2:1 to 7:1, or 3:1 to 5:1. In other embodiment, the aromatic sulfonic acid is dissolved in a minimum amount of solvent, the solvent comprising ethylene glycol, propylene glycol, dipropylene glycol, triethylene glycol, butyrolactone, dimethyl sulfoxide, N-methyl-2-pyrrolidone, morpholines, propane diol, or mixtures thereof. A catalyst, such as an aromatic sulfonic acid is normally required to produce the foam but in some cases, a foam can be made without a catalyst but rather using thermal aging. A combination of thermal aging and a catalyst is commonly used. In some cases, the reaction is exothermic and hence little or no additional heat may be required.

In an embodiment, the process of making a LFR foam also comprises adding an organic anhydride to at least one of the lignin-furfuryl alcohol composition, the phenolic-resole, or the LFR composition.

The amount of organic anhydride is in the range of 0.5-20%, or 1-15%, or 1-10%, based on the total weight of the LFR composition, excluding the weight of blowing agent. In an embodiment, the organic anhydride comprises maleic anhydride.

The process also comprises adding a surfactant to at least one of the steps described herein above. In an embodiment, the surfactant is first mixed with the blowing agent and then the mixture of blowing agent and surfactant is mixed with the lignin-furfuryl alcohol composition or to the lignin-phenol resole mixture. The surfactant is added to lower the surface tension and stabilize the foam cells during foaming and curing. The surfactant is at least one of ionic or non-ionic surfactants, including polymeric surfactants, as disclosed hereinabove. In another embodiment, a surfactant is mixed with the acid catalyst, such as aromatic sulfonic acid. The amount of surfactant present is in the range of about 0.01 wt % to about 10 wt %, or 1 wt % to about 8 wt %, or 3 wt % to about 6 wt %, based on the total weight of the foamble-LFR composition, excluding the weight of blowing agent.

In an embodiment, the process of making a LFR foam further comprises adding about 1 wt % to about 20 wt % or about 1 wt % to about 10 wt % of urea to the foamble-LFR composition, based on the total weight of the foamble-LFR composition, excluding the weight of blowing agent. In one embodiment, urea is added to the phenolic-resole. In yet another embodiment, urea is added to the LFR composition.

In another embodiment, the process of making a lignin-based foam further comprises adding an additive to the foamable-LFR composition. The amount of additive is in the range of 5 wt % to about 50 wt % or about 10 wt % to about 45 wt %, or about 15 wt % to about 40 wt %, by weight based on the total weight of the LFR foam composition. Suitable additives include, but are not limited to, cellulose fiber, bacterial cellulose, sisal fiber, clays, Kaolin-type clay, mica, vermiculite, sepiolite, hydrotalcite and other inorganic platelet materials, glass fibers, polymeric fibers, alumina fibers, aluminosilicate fibers, carbon fibers, carbon nanofibers, poly-1,3-glucan, lyocel fibers, chitosan, boehmite (AlO.OH), zirconium oxide, or mixtures thereof. The additive can also be a plasticizer comprising a polyester polyol, formed by the reaction of a polybasic carboxylic acid with a polyhydridic alcohol selected from a dihydridic to a pentahydridic. Examples of the acid include but are not limited to adipic acid, sebacic acid, naphthalene-2,6-dicarboxylic acid, cyclohexane-1,3-dicarboxylic acid, phthalic acid. Examples of the polyhydric alcohol include but are not limited to ethylene glycol, propylene diol, propylene glycol, 1,6-hexane diol, 1,4-butane diol and 1,5-pentane diol. In an embodiment, the plasticizer is polyester polyol. The average molecular weight is in the range of about 100 g/mol to about 50,000 g/mol, or about 200 g/mol to about 40,000 g/mol, or about 200 g/mol to about 1000 g/mol.

The process of making a LFR foam also comprises foaming and curing the foamable-LFR composition to form a LFR foam comprising a polymeric phase defining a plurality of cells, wherein the polymeric phase comprises lignin-furfuryl alcohol-resole copolymer. The LFR foam also comprises a discontinuous phase comprising the one or more blowing agents disposed in at least a portion of the plurality of cells. The step of processing the composition comprises maintaining the composition at an optimum temperature. In an embodiment, the optimum temperature is in the range of about 50° C. to about 100° C., or about 60° C. to about 90° C. In another embodiment, the step of processing the composition comprises foaming the composition in a substantially closed mold or in a continuous foam line. In one embodiment, the composition is first foamed at an optimum temperature in an open mold and then the mold is closed and kept at that temperature for a certain amount of time. As used herein, the term “closed mold” means partially closed mold where some gas may escape, or completely closed mold, where the system is sealed. In some cases, the foam is formed in a closed mold or under application of pressure to control the foam density. Pressures from atmospheric to up to 5000 kPa may be applied depending upon the desired foam density.

In one embodiment, the process of making a LFR foam further comprises disposing a lignin-based foam between two similar or dissimilar non-foam materials, also called facers to form a sandwich panel structure.

Non-limiting examples of the process disclosed herein include:
1. A lignin-furfuryl alcohol-resole (LFR) composition comprising:
   (i) 10-90 wt % of a lignin-furfuryl alcohol composition derived from a lignin, water, and one or more lignin reactive monomers, wherein at least one of the one or more lignin reactive monomers is furfuryl alcohol;
   (ii) 10-90 wt % of a phenolic-resole derived from a phenol and a phenol-reactive monomer; and
   (iii) optionally 0.1-10 wt % of an organic amine comprising urea, melamine, hexamine, or mixtures thereof, wherein the amounts in wt % are based on the total weight of the LFR composition.
2. The LFR composition of embodiment 1, wherein the phenol-reactive monomer comprises at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof.
3. The LFR composition of embodiment 1 or 2, wherein the phenol-reactive monomer is formaldehyde.
4. The LFR composition of embodiment 1, 2, or 3, further comprising at least one of an organic anhydride, a surfactant, and a plasticizer.
5. A thermoset polymer derived from the LFR composition of embodiment 1, 2, 3, or 4.
6. A thermoset polymer derived from the LFR composition of embodiment 1, 2, 3, 4, or 5 and at least one of urea-formaldehyde resin, melamine-formaldehyde resin and resorcinol-formaldehyde resin.
7. A lignin-furfuryl alcohol-resole (LFR) foam comprising:
   (i) a polymeric phase defining a plurality of open cells and a plurality of closed cells, and
   (ii) a gas phase comprising one or more blowing agents disposed in at least a portion of the plurality of closed cells,
   wherein the polymeric phase is derived from:
      c) a lignin-furfuryl alcohol composition derived from a lignin, water, and one or more lignin reactive monomers, wherein at least one of the one or more lignin reactive monomers is furfuryl alcohol, and
      d) a phenol-formaldehyde resole.
8. The LFR foam of embodiment 7, wherein at least one of the one or more blowing agents comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.
9. The LFR foam of embodiment 7, wherein at least one of the one or more blowing agents comprises an azeotrope or an azeotrope-like mixture of isopentane and one other blowing agent selected from the group consisting of isopropyl chloride, 1,1,1,4,4,4-hexafluoro-2-butene and 1-chloro-3,3,3,-trifluoropropene.
10. The LFR foam of embodiment 7, 8, or 9, wherein the blowing agent comprises a mixture of isopropyl chloride and isopentane.
11. An article comprising the LFR foam of embodiment 7, 8, 9, or 10.
12. The article of embodiment 11 comprising a sandwich panel structure, wherein the sandwich panel structure comprises the LFR foam disposed between two similar or dissimilar non-foam materials.
13. A foam formed by foaming and curing a composition at a temperature in the range of 50-100° C., the composition comprising
   a. a lignin-furfuryl alcohol composition derived from a lignin, water, and one or more lignin reactive monomers, wherein at least one of the one or more lignin reactive monomers is furfuryl alcohol,
   b. a phenolic-resole,
   c. a blowing agent,
   d. an acid catalyst, and
   e. a surfactant.
14. A method of making a lignin-furfuryl alcohol-resole (LFR) foam comprising:
   a) forming a lignin-furfuryl alcohol composition from a lignin, water, and one or more lignin reactive monomers, wherein at least one of the one or more lignin reactive monomers is furfuryl alcohol;
   b) adding a phenolic-resole to the lignin-furfuryl alcohol composition of step (a) to form a lignin-furfuryl alcohol-resole (LFR) composition, wherein the phenolic-resole is derived from a phenol and a phenol-reactive monomer comprising at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof;
   c) adding at least one blowing agent to the LFR composition of step (b);
   d) adding an aromatic sulfonic acid to the LFR composition of step (b) or (c) to form a foamable-LFR composition;
   e) adding a surfactant to at least one of the steps (a), (b), (c) or (d); and
   f) foaming and curing the foamable-LFR composition at a temperature in the range of 50-100° C. to form a foam comprising a polymeric phase defining a plurality of open cells and a plurality of closed cells,
      wherein the polymeric phase is derived from the lignin-furfuryl alcohol-resole (LFR) composition.
15. The method of embodiment 14, wherein the aromatic sulfonic acid comprises para-toluenesulphonic acid and xylenesulphonic acid.
16. The method of embodiment 14 or 15, wherein the at least one blowing agent comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.
17. The method of embodiment 14, 15, or 16 further comprising disposing the foam between two similar or dissimilar non-foam materials to form a sandwich panel structure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the phrase “one or more” is intended to cover a non-exclusive inclusion. For example, one or more of A, B, and C implies any one of the following: A alone, B alone, C alone, a combination of A and B, a combination of B and C, a combination of A and C, or a combination of A, B, and C.

Also, use of “a” or “an” are employed to describe elements and described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

In the foregoing specification, the concepts have been disclosed with reference to specific embodiments. However, one of ordinary skill in the art appreciates that various modifications and changes can be made without departing from the scope of the invention as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

The concepts disclosed herein will be further described in the following examples, which do not limit the scope of the invention described in the claims.

### EXAMPLES

### Test Methods

### Density

Apparent density (p) of the foams was measured by a) cutting a foam into a regular shape such as a rectangular cube or cylinder, b) measuring the dimensions and the weight of the foam piece, c) evaluating the volume of the foam piece and then dividing the weight of the foam piece by the volume of the foam piece.

More specifically, three cylindrical pieces were cut from a test foam using a brass corer having an internal diameter of 1.651 mm (0.065″) to calculate the average apparent density of the test foam. The diameter and the length of the cylindrical pieces were measured using Vernier calipers and then the volume (V) of the cylinder was calculated. The mass (m) of each cylindrical piece was measured and used to calculate the apparent density (ρₐ) of each foam piece.

$${ρ}_{a} = \frac{m}{V}$$

### Open-Cell Content

Open-cell content of foams was determined using ASTM standard D6226-5. All measurements were made at room temperature of 24° C.

Pycnometer density (p) of each cylindrical piece was measured using a gas pycnometer, Model # Accupyc 1330 (Micromeritics Instrument Corporation, Georgia, U.S.A) at room temperature using nitrogen gas.

The AccuPyc works by measuring the amount of displaced gas. A cylindrical foam piece was placed in the pycnometer chamber and by measuring the pressures upon filling the chamber with a test gas and discharging it into a second empty chamber, volume (Vₛ) of the cylindrical foam piece that was not accessible to the test gas was calculated. This measurement was repeated five times for each foam cylindrical piece and the average value for Vₛ was calculated.

The volume fraction of open-cells (Oᵥ) in a foam sample was calculated by the following formula:

$${O}_{v} = \frac{( V - {V}_{s} )}{V}$$

Assuming the specific gravity of the solid tannin polymer to be 1 g/cm³, the volume fraction of the cell walls (CWᵥ) was calculated from the following formula:

$${CW}_{v} = \frac{m}{V}$$

Thus the volume fraction of closed cells (Cᵥ) was estimated by the following equation:

Cᵥ=1−Oᵥ−CWᵥ

### Thermal Conductivity

Hot Disk Model # PPS 2500S (Hot Disk AB, Gothenberg, Sweden) was used to measure thermal conductivities of the foams at room temperature.

A foam whose thermal conductivity needed to be measured was cut into two rectangular or circular test pieces of same size. The lateral dimensions and the thickness of the foam pieces were required to be greater than four times the radius of the Hot Disk heater and sensor coil. The radius of the heater and sensor coil for all measurements was 6.4 mm and hence the lateral dimensions and the thickness of the foam pieces were greater than 26 mm.

Before the start of a measurement protocol, the heater and sensor coil was sandwiched between two test pieces of foam and the entire assembly was clamped together to ensure intimate contact between the surfaces of the foam pieces and the heater and sensor coil.

At the start of a test, a known current and voltage was applied to the heater and sensor coil. As the heater and sensor coil heated up due to the passage of current through the coil, the energy was dissipated to the surrounding test pieces of foam. At regular time intervals during the experiment, the resistance of the heater and sensor coil was also measured using a precise wheat stone bridge built into the Hot Disk apparatus. The resistance was used to estimate the instantaneous temperature of the coil. The temperature history of the heater and sensor coil was then used to calculate the thermal conductivity of the foam using mathematical analysis presented in detail by Yi He in Thermochimica Acta 436, pp 122-129, 2005.

The test pieces of foam were allowed to cool and the thermal conductivity measurement on the test pieces was repeated two more times. The thermal conductivity data was then used to calculate the average thermal conductivity of the foam.

### Moisture Content in Lignin

The lignins obtained from the commercial sources contain significant amount of water and the amount of water varies from source to source. The moisture content of the commercially obtained lignin was measured by first drying the lignin in a vacuum oven at 85° C. for 5 days and then the water content of the lignin was calculated by measuring the dried and wet lignin samples.

Viscosity

The viscosity of the solutions or emulsions were measured using Brookfield viscometer fitted with a small sample adaptor, plumbed to a temperature controlled water bath and using bob #27. The viscosity values are reported in centipoise (cP).

### Starting Materials

All commercial materials were used as received unless otherwise indicated. Kraft lignin (hardwood and softwood) was received from FP Innovations (Ontario, Canada) and Domtar Corporation will be referred to as L-HW-FP (for Hardwood), L-SW-FP (Softwood) from FP Innovations and L-HW-D (Hardwood) from Domtar. Furfuryl alcohol and urea were obtained from Sigma-Aldrich (St. Louis, Mo.).

Phenol (unstabilized, ACROS Chemicals) and formaldehyde (Sigma-Aldrich (St. Louis, Mo.) were used as received. Acid catalyst used was a mixture of 70/30 wt % of p-toluene sulfonic acid and p-xylene sulfonic acid (p-TSA/p-XSA) either in monomeric ethylene glycol (70% solution) (MEG) or triethylene glycol (80% solution) (TEG) and was obtained from DynaChem Inc. Blowing agents cyclopentane, isopentane, and isopropyl chloride were purchased from Sigma-Aldrich. FEA-1100 (Formacel®, DuPont). Surfactants used were: Tween® 40 was purchased from Sigma-Aldrich (St. Louis, Mo.), Tegostab® B8406, a silicone surfactant was purchased from Evonik Goldschmidt Corporation (Hopewell, Va.) and Lumulse® CO-30, an ethoxylated vegetable oil was obtained from Lambent Technologies (Gurnee, Ill.).

Phenol-formaldehyde resole (R3-281) was obtained from Dynachem Inc (Westville, Ill.) and will be referred to as Resole-D, had the properties summarized in Table 1.

Phenol-formaldehyde resole was also synthesized in the lab as described below and will be referred to as Resole-L.

### Preparation of Phenol-Formaldehyde Resole (Resole-L)

A phenol-formaldehyde resole, Resole-L was prepared by reaction of 752.88 g (8.00 moles) of phenol with 1424.45 g (17.60 moles) of a 37% formaldehyde solution in a 3 L, three-neck flask fitted with an overhead stirrer and a reflux condenser cooled with a recirculation bath. The pH was adjusted to 8-9 using 7.984 g of 50 wt % sodium hydroxide (0.53 wt % based on phenol) at room temperature. The flask and contents were suspended in an oil bath and the reaction mixture was heated at 1° C./min to an internal temperature of 90° C. and maintained at 90° C. for an additional 150 minutes. This solution was then cooled to room temperature in an ice bath. The solution in the reaction flask was adjusted from 7.67 to pH 7.00 at 25° C. by the addition of 16.255 g of 10 wt % hydrochloric acid. The reaction solution (2201.57 g) was split into half and transferred in two 2000 mL round bottom flasks. The content in each flask (1097.03 g) was concentrated via rotary evaporation in an 80° C. bath to 56.56% (620.52 g) of the original weight (at rotation setting of 6, 200 mbar to 70 mbar over 4 min and hold for 32 min). The hot concentrated fractions were combined and mixed thoroughly. The resole solution was stored in a refrigerator until it was used. The resole was characterized by SEC, GC, Karlfisher titration and had the properties, as summarized in Table 1.

TABLE 1
Properties of Phenol-formaldehyde Resoles

| | Resole-D | Resole-L |
|---|---|---|
| | (obtained from | (Synthesized |
| | Dynachem, Inc) | in the lab) |
| Number average molecular weight (Mn) | 305 | 302 |
| Weight average molecular weight (Mw) | 456 | 540 |
| Free phenol in resole, wt % | 4.62 | 6.43 |
| Free formaldehyde in resole, wt % | 2.14 | 9.08 |
| Water content in resole, wt % | 5.73 | 5.30 |
| Viscosity at 25° C. | 20,400 cP | — |

### Example 1: Preparation of Lignin-Furfuryl Alcohol-Resole Foam from Hardwood Lignin (LFRF-1)

### Step 1a: Preparation of Lignin-Furfuryl Alcohol Composition (L-1)

A lignin-furfuryl alcohol composition was prepared by adding 122.0 g of hardwood lignin, L-HW-FP (contains 5.609 wt % water) to a mixture of furfuryl alcohol (83.20 g) water (16.36 g) and TWEEN 40 (8.90 g). The mixture was stirred at room temperature and 250 RPM for 15 minutes resulting in an internal temperature rise to 29° C. This lignin-furfuryl alcohol composition, L-1 had a viscosity of 15,200 cP at 25° C. Table 2 summarizes the weight percentages of each added ingredient and process conditions in preparing the lignin-furfuryl alcohol composition.

### Step 1 b: Preparation of Lignin-Furfuryl Alcohol-Resole (LFR-1) Composition

A lignin-furfuryl alcohol-resole composition was prepared by adding the lignin-furfuryl alcohol composition (20.00 g), L-1 of Step 1a, to a 100 mL beaker that contained 20.00 g of the phenol-formaldehyde resole, Resole-L as disclosed supra, and an additional 0.80 g of TWEEN 40 surfactant. The mixture was blended together thoroughly by mixing with a helical, mechanical stirrer attached to an overhead stirrer set to 400 rpm for several minutes at room temperature, to obtain the LPF-1 resole composition.

### Step 1c: Preparation of LFR Rigid Foam (LFRF-1)

The blowing agent, cyclopentane (3.05 g), was added incrementally to the LFR-1 solution of Step 1 b, until a stable weight was reached. The mixture was placed into an ice bath and allowed to sit undisturbed for 5 minutes. Next, 5.60 g of precooled acid catalyst (70 wt % of 70/30 mixture of p-TSA/p-XSA in MEG), which was precooled in a freezer for 30 minutes was added to the mixture and the reaction was mixed for 30 seconds. A portion of the mixture (15.8 g) was poured into a 3″×3″×2″ paper box, placed the box into a preheated mold and kept in a preheated oven at 55° C. under atmospheric pressure for foaming and curing to take place. After 15 minutes, the cardboard box was taken out of the metal mold and left to cure overnight at 55° C. The properties of the cured LFRF-1 foam are summarized in Table 3.

### Example 2: Preparation of Lignin-Furfuryl Alcohol-Resole Foam from Hardwood Lignin (LFRF-2)

### Step 2a: Preparation of Lignin-Furfuryl Alcohol Composition (L-2)

A lignin-furfuryl alcohol composition was prepared by adding 108.8 g of dried hardwood lignin, L-HW-D (milled in Wiley mill) to a mixture of furfuryl alcohol (78.34 g) and TWEEN 40 (8.70 g). The mixture was stirred at room temperature and 250 RPM for 15 minutes and then water (21.76 g) was added while stirring. Then the flask was immersed into an oil bath at 70° C. while stirring the mixture at 350 rpm. After 2.5 hours of stirring, the black mixture was transferred into a plastic bottle.

Table 2 summarizes the weight percentages of each added ingredient and process conditions in preparing the lignin-furfuryl alcohol composition.

### Step 2b: Preparation of Lignin-Furfuryl Alcohol-Resole (LFR-2) Composition

A lignin-furfuryl alcohol-resole composition was prepared by adding the lignin-furfuryl alcohol composition (20.00 g), L-2 of Step 2a, to a 100 mL beaker that contained 20.00 g of the phenol-formaldehyde resole, Resole-L as disclosed supra, and an additional 0.80 g of TWEEN 40 surfactant. The mixture was blended together thoroughly by mixing with a helical, mechanical stirrer attached to an overhead stirrer set to 300 rpm for several minutes at room temperature, to obtain the LFR-2 resole composition.

### Step 2c: Preparation of LFR Rigid Foam (LFRF-2)

The blowing agent, cyclopentane (2.96 g), was added incrementally to the LFR-2 solution of Step 2b, until a stable weight was reached. The mixture was placed into an ice bath and allowed to sit undisturbed for 5 minutes. Next, 5.60 g of precooled acid catalyst (70 wt % of 70/30 mixture of p-TSA/p-XSA in MEG), which was precooled in a freezer for 30 minutes, was added to the mixture and the reaction was mixed for 30 seconds. A portion of the mixture (14.8 g) was poured into a 3″×3″×2″ paper box, placed the box into a preheated mold and kept in a preheated oven at 50° C. under atmospheric pressure for foaming and curing to take place. After 15 minutes, the cardboard box was taken out of the metal mold and left to cure overnight at 50° C. The properties of the cured LFRF-2 foam are summarized in Table 3.

### Example 3: Preparation of Lignin-Furfuryl Alcohol-Resole Foam from Hardwood Lignin (LFRF-3)

### Step 3a: Preparation of Lignin-Furfuryl Alcohol Composition (L-3)

A lignin-furfuryl alcohol composition was prepared by adding 67.41 g of hardwood lignin, L-HW-FP (contains 13.24 wt % water) to a mixture of furfuryl alcohol (40.47 g) water (3.84 g) and Tegostab B8406 (4.04 g). The mixture was stirred at room temperature and 250 RPM for 15 minutes. Then the flask was immersed into an oil bath at 60° C. while stirring the mixture at 350 rpm. After 3.0 hours of stirring, the black mixture was transferred into a plastic bottle. This lignin-furfuryl alcohol composition, L-3 had a viscosity in the range of 38000-43000 cP at 25° C.

Table 2 summarizes the weight percentages of each added ingredient and process conditions in preparing the lignin-furfuryl alcohol composition.

### Step 3b: Preparation of Lignin-Furfuryl Alcohol-Resole (LFR-3) Composition

A lignin-furfuryl alcohol-resole composition was prepared by adding the lignin-furfuryl alcohol composition (30.00 g), L-3 of Step 3a, to a 100 mL beaker that contained 30.00 g of the phenol-formaldehyde resole, Resole-D, and an additional 0.68 g of TWEEN 40 surfactant. The mixture was blended together thoroughly by mixing with a helical, mechanical stirrer attached to an overhead stirrer set to 400 rpm for several minutes at room temperature, to obtain the LFR-3 resole composition.

### Step 3c: Preparation of LFR Rigid Foam (LFRF-3)

The blowing agent, FEA 1100 (4.55 g), was added incrementally to the LFR-3 solution of Step 3b, until a stable weight was reached. The mixture was placed into an ice bath and allowed to sit undisturbed for 5 minutes. Next, 4.52 g of precooled acid catalyst (70 wt % of 70/30 mixture of p-TSA/p-XSA in MEG), which was precooled in a freezer for 30 minutes, was added to the mixture and the reaction was mixed for 30 seconds. A portion of the mixture (18.06 g) was poured into a 3″×3″×2″ paper box, placed the box into a preheated mold and kept in a preheated oven at 60° C. under atmospheric pressure for foaming and curing to take place. After 15 minutes, the cardboard box was taken out of the metal mold and left to cure overnight at 60° C. The properties of the cured LFRF-3 foam are summarized in Table 3.

### Example 4: Preparation of Lignin-Furfuryl Alcohol-Resole Foam from Softwood Lignin (LFRF-4)

### Step 4a: Preparation of Lignin-Furfuryl Alcohol Composition (L-4)

A lignin-furfuryl alcohol composition was prepared by adding 202.3 g of softwood lignin, L-SW-FP (contains 5.85 wt % water) to a mixture of furfuryl alcohol (131.75 g) water (29.75 g) and Tegostab B8406 (13.16 g). The mixture was stirred at room temperature and 250 RPM for 20 minutes. Then the flask was immersed into an oil bath at 65° C. while stirring the mixture at 350 rpm. After 3.25 hours of stirring, the black and thick viscous mixture was transferred into a plastic bottle and allowed to cool to room temperature.

Table 2 summarizes the weight percentages of each added ingredient and process conditions in preparing the lignin-furfuryl alcohol composition.

### Step 4b: Preparation of Lignin-Furfuryl Alcohol-Resole (LFR-4) Composition

A lignin-furfuryl alcohol-resole composition was prepared by adding the lignin-furfuryl alcohol composition (30.00 g), L-4 of Step 4a, to a 100 mL beaker that contained 30.00 g of the phenol-formaldehyde resole, Resole-D, and an additional 1.35 g of TWEEN 40 surfactant. The mixture was blended together thoroughly by mixing with a helical, mechanical stirrer attached to an overhead stirrer set to 400 rpm for several minutes at room temperature, to obtain the LPF-4 resole composition.

### Step 4c: Preparation of LFR Rigid Foam (LFRF-4)

The blowing agent, FEA 1100 (9.35 g), was added incrementally to the LFR-3 solution of Step 4b, until a stable weight was reached. The mixture was placed into an ice bath and allowed to sit undisturbed for 5 minutes. Next, 8.40 g of precooled acid catalyst (70 wt % of 70/30 mixture of p-TSA/p-XSA in MEG), which was precooled in a freezer for 30 minutes, was added to the mixture and the reaction was mixed for 30 seconds. A portion of the mixture (14.45 g) was poured into a 3″×3″×2″ paper box, placed the box into a preheated mold and kept in a preheated oven at 60° C. under atmospheric pressure for foaming and curing to take place. After 15 minutes, the cardboard box was taken out of the metal mold and left to cure overnight at 60° C. The properties of the cured LFRF-4 foam are summarized in Table 3.

### Example 5: Preparation of Lignin-Furfuryl Alcohol-Resole Foam from Softwood Lignin (LFRF-5)

The LFRF-5 was prepared as described in Example 4 except the blowing agent FEA 1100 was replaced with 4.3 g pentane. The properties of the cured LFRF-5 foam are summarized in Table 3.

### Example 6: Preparation of Lignin-Furfuryl Alcohol-Resole Insulation Foam from Hardwood Lignin (LFRF-6)

### Step 6a: Preparation of Lignin-Furfuryl Alcohol Composition (L-6)

A lignin-furfuryl alcohol composition was prepared by adding 122.0 g of hardwood lignin, L-HW-FP (contains 5.61 wt % water) to a mixture of furfuryl alcohol (90.0 g) water (18.36 g) and TWEEN 40 (9.5 g). The mixture was stirred at room temperature and 250 RPM for 20 minutes. Then the flask was immersed into an oil bath at 70° C. while stirring the mixture at 350 rpm. After 2.5 hours of stirring, the dark and thick viscous mixture was transferred into a plastic bottle and allowed to cool to room temperature.

Table 2 summarizes the weight percentages of each added ingredient and process conditions in preparing the lignin-furfuryl alcohol composition.

### Step 6b: Preparation of Lignin-Furfuryl Alcohol-Resole (LFR-6) Composition

A lignin-furfuryl alcohol-resole composition was prepared by adding the lignin-furfuryl alcohol composition (25.00 g), L-6 of Step 6a, to a 100 mL beaker that contained 25.00 g of the phenol-formaldehyde resole, Resole-L as disclosed supra, and an additional 1.0 g of TWEEN 40 surfactant. The mixture was blended together thoroughly by mixing with a helical, mechanical stirrer attached to an overhead stirrer set to 400 rpm for several minutes at room temperature, to obtain the LPF-6 resole composition.

### Step 6c: Preparation of LFR Rigid Insulation Foam (LFRF-6)

The blowing agent, cyclopentane (3.86 g), was added incrementally to the LFR-6 solution of Step 6b, until a stable weight was reached. The mixture was placed into an ice bath and allowed to sit undisturbed for 5 minutes. Next, 5.60 g of precooled acid catalyst (70 wt % of 70/30 mixture of p-TSA/p-XSA in MEG), which was precooled in a freezer for 30 minutes, was added to the mixture and the reaction was mixed for 30 seconds. A portion of the mixture (16.75 g) was poured into a 3″×3″×2″ paper box, placed the box into a preheated mold and kept in a preheated oven at 55° C. under atmospheric pressure for foaming and curing to take place. After 15 minutes, the cardboard box was taken out of the metal mold and left to cure overnight at 55° C. The properties of the cured LFRF-6 foam were measured after 2 months and reported in Table 3.

### Example 7: Preparation of Lignin-Furfuryl Alcohol-Resole Insulation Foam from Hardwood Lignin (LFRF-7)

### Step 7a: Preparation of Lignin-Furfuryl Alcohol Composition (L-7)

A lignin-furfuryl alcohol composition was prepared by adding 610.0 g of hardwood lignin, L-HW-FP (contains 5.61 wt % water) to a mixture of furfuryl alcohol (416.0 g) water (81.8 g) and TWEEN 40 (44.6 g). The mixture was stirred at room temperature and 250 RPM for 20 minutes. Then the flask was immersed into an oil bath at 60° C. while stirring the mixture at 350 rpm. After 4.5 hours of stirring, the dark and thick viscous mixture was transferred into a plastic bottle and allowed to cool to room temperature.

Table 2 summarizes the weight percentages of each added ingredient and process conditions in preparing the lignin-furfuryl alcohol composition.

### Step 7b: Preparation of Lignin-Furfuryl Alcohol-Resole (LFR-7) Composition

A lignin-furfuryl alcohol-resole composition was prepared by adding the lignin-furfuryl alcohol composition (20.00 g), L-7 of Step 7a, to a 100 mL beaker that contained 20.00 g of the phenol-formaldehyde resole, Resole-L as disclosed supra, and an additional 0.80 g of TWEEN 40 surfactant. The mixture was blended together thoroughly by mixing with a helical, mechanical stirrer attached to an overhead stirrer set to 400 rpm for several minutes at room temperature, to obtain the LPF-7 resole composition.

### Step 7c: Preparation of LFR Rigid Insulation Foam (LFRF-7)

The blowing agent, cyclopentane (3.03 g), was added incrementally to the LFR-6 solution of Step 6b, until a stable weight was reached. The mixture was placed into an ice bath and allowed to sit undisturbed for 5 minutes. Next, 5.60 g of precooled acid catalyst (70 wt % of 70/30 mixture of p-TSA/p-XSA in MEG), which was precooled in a freezer for 30 minutes, was added to the mixture and the reaction was mixed for 30 seconds. A portion of the mixture (14.7 g) was poured into a 3″×3″×2″ paper box, placed the box into a preheated mold and kept in a preheated oven at 55° C. under atmospheric pressure for foaming and curing to take place. After 15 minutes, the cardboard box was taken out of the metal mold and left to cure overnight at 55° C. The properties of cured LFRF-7 were measured and summarized in Table 3.

### Example 8: Preparation of Lignin-Furfuryl Alcohol-Resole Insulation Foam from Hardwood Lignin (LFRF-8)

The process of making foam LFRF-8 was duplicated as described in Example 7 to see the process reproducibility and consistency in the cured foam properties. The properties of cured LFRF-7 were measured and summarized in Table 3.

TABLE 2
Process conditions of various lignin-furfuryl alcohol compositions

| | Lignin- | | | | | | | |
|---|---|---|---|---|---|---|---|---|
| | furfuryl | | | | | | | Viscosity @ |
| | alcohol | Lignin | FA | H₂O | | Temp | | 25° C. |
| Ex | composition | Wt % | Wt % | Wt % | Surfactant | ° C. | Time h | cP |
| 1 | L-1 | 49.93 | 36.1 | 10.11 | 3.86% | RT | 0.4 | 15200 |
| | | | | | Tween ® 40 | | | |
| 2 | L-2 | 50.0 | 36.0 | 10.0 | 4.0% | 70 | 2.5 | 40500 ± 2500 |
| | | | | | Tween ® 40 | | | |
| 3 | L-3 | 50.52 | 34.96 | 11.03 | 3.5% | 60 | 3.0 | 40500 ± 2500 |
| 4 | L-4 | | | | Tegostab | 65 | 3.25 | NM |
| 5 | L-5 | | | | B8406 | 65 | 3.25 | |
| 6 | L-6 | 48.01 | 37.52 | 10.51 | 3.96% | 70 | 2.5 | |
| | | | | | Tween ® 40 | | | |
| 7 | L-7 | 50.0 | 36.1 | 10.1 | 3.9% | 60 | 4.5 | |
| | | | | | Tween ® 40 | | | |
| 8 | L-8 | 50.0 | 36.1 | 10.1 | 3.9% | 60 | 4.5 | |
| | | | | | Tween ® 40 | | | |
| 9-13 | L-9 | 48.0 | 37.5 | 14.5 | none | 70 | 2.5 | 204,000 @ |
| | | | | | | | | 45° C. |

NM = not measured

As shown in the Table 2, the viscosity of the lignin-furfuryl alcohol composition (L-1) that was prepared at room temperature (RT) was significantly lower than the lignin-furfuryl alcohol composition (L-2) that was prepared at elevated temperature. It is also clear that the viscosity of the lignin-furfuryl alcohol composition (L-9) is significantly higher when prepared without surfactant than with the lignin-furfuryl alcohol compositions (L-2 or L-6) prepared with surfactant, all at a temperature of 70° C. The lower viscosity of the lignin-furfuryl alcohol composition in the presence of surfactant may be due to emulsion/dispersion state rather than solution which is preferred because lower viscosity solution is much easier to process and handle.

Although not to be bound by any theory, it is believed that the higher viscosity of the lignin-furfuryl alcohol composition is due to the presence of oligomers, either from self-condensation of furfuryl alcohol or from reaction between furfuryl alcohol (FA) and lignin molecules at higher temperatures. To confirm this hypothesis, three separate reactions were conducted:
1. For control experiment, aqueous furfuryl alcohol solution was polymerized in the presence of 0.5% of 1M sulfuric acid solution at a temperature of 95° C. for 4 hours to form oligomers of furfuryl alcohol. These furfuryl alcohol oligomers were isolated from the reaction mixture and characterized by proton NMR (control experiment).
2. In a separate experiment, phenol was used instead of complex lignin, and reacted with furfuryl alcohol and water with no added acid catalyst at a temperature of 90° C. for 8 hours. The reaction mixture was slightly acidic due to the presence of phenol. The heated reaction mixture was analyzed by proton NMR and showed the presence of furfuryl alcohol oligomers, unreacted furfuryl alcohol and phenol in the mixture.
3. A comparative experiment was also conducted where once again phenol was used instead of complex lignin, and reacted with furfuryl alcohol and water under basic condition (pH=8.3) using 50% aq NaOH as a base at a temperature of 90° C. for 8 hours. The proton NMR analysis of this reaction mixture showed no oligomeric furfuryl alcohol.

Since furfuryl alcohol oligomers were formed only under acidic conditions and lignin-furfuryl alcohol compositions are found to be acidic (pH of 2.5 was measured for Examples 9-13), it can be concluded that the increase in viscosity of lignin-furfuryl alcohol composition at elevated temperature is partly if not completely as a result of oligomerization of furfuryl alcohol. It is speculated that furfuryl alcohol besides self-condensation may also react with lignin to form oligomers, thereby increasing viscosity.

TABLE 3
Properties of rigid insulation LFR foams

| | | | | | Apparent | Open- | Thermal |
|---|---|---|---|---|---|---|---|
| | | Lignin | Blowing | | density | cells | conductivity |
| Example | Foam | Type | Agent | Surfactant | (kg/m³) | (%) | (mW/m · K) |
| 1 | LFRF-1 | L-HW-FP | Cyclo- | TWEEN | 42.2 | 32.8 | NM |
| 2 | LFRF-2 | L-HW-D | pentane | 40 | 39.8 | 20.6 | 29.1 |
| 3 | LFRF-3 | L-HW-FP | FEA- | Tegostab | 36.9 | 20.2 | 29.1 |
| 4 | LFRF-4 | L-SW-FP | 1100 | B8406 & | 42 | 9.6 | 27.4 |
| 5 | LFRF-5 | L-SW-FP | Pentane | TWEEN | 37.5 | 15.3 | 28.4 |
| | | | | 40 | | | |
| 6 | LFRF-6 | L-HW-FP | Cyclo- | TWEEN | 40.8 | 9.4 | 23.5 |
| 7 | LFRF-7 | L-HW-FP | pentane | 40 | 42.4 | 8.2 | 23.6 |
| 8 | LFRF-8 | L-HW-FP | | | 43.5 | 7.3 | 23.7 |

NM = not measured

As shown in Table 3, all of the foamable-LFR compositions comprising lignin led to low density foams in the range of 37-43 kg/m³ with variations in the open cell content and thermal conductivity. It appears that the insulation properties (open-cell and thermal conductivity) of the final foam depend on type of lignin, its reactivity and process conditions such as the viscosity of the final lignin-furfuryl alcohol-resole solution. The foams obtained from the foamable-LFR compositions described in Examples 6-8 have excellent insulation properties with open-cell content of less than 10% and thermal conductivity of less than 24 mW/mK, and therefore these foams could be useful as insulation foams. Though the foams described in Examples 1 and 2 were made using the same type of lignin, blowing agent and surfactant, they had significantly higher open cell content and higher thermal conductivity than the foams described in Examples 6-8 which clearly suggest that the process conditions play a key role on cell morphology.

The properties of the foam described in Example 6 were measured two months after the foam was made. Since the thermal conductivity of an insulation foam generally increases with aging, the low thermal conductivity value of the foam LFRF-6 of Example 6 indicates good stability.

### Examples 9-13: Preparation of Lignin-Furfuryl Alcohol-Resole Insulation Foam from Hardwood Lignin

Step 9a: Preparation of Lignin-Furfuryl Alcohol Composition (L-9) without Surfactant

A lignin-furfuryl alcohol composition was prepared by adding 356.0 g of hardwood lignin, L-HW-FP (contains 5.61 wt % water) to a mixture of furfuryl alcohol (262.5 g) and water (81.5 g). The mixture was stirred at room temperature and 250 RPM for 20 minutes. Then the flask was immersed into an oil bath at 70° C. while stirring the mixture at 350 rpm. After 2.5 hours of stirring, the dark and thick viscous mixture was transferred into a plastic bottle and allowed to cool to room temperature. The pH of the solution was measured using a pH probe at 50° C. and found to be 2.5 and the viscosity was about 204000 cP at 45° C. Table 2 summarizes the weight percentages of each added ingredient and process conditions in preparing the lignin-furfuryl alcohol composition.

### Step 9b: Preparation of Lignin-Furfuryl Alcohol-Resole (LFR-9) Composition

A lignin-furfuryl alcohol-resole composition was prepared by adding the lignin-furfuryl alcohol composition (50 wt %), L-9 of Step 9a, to a 100 mL beaker that contained the phenol-formaldehyde resole, Resole-L (50 wt %), The mixture was blended together thoroughly by mixing with a helical, mechanical stirrer attached to an overhead stirrer set to 400 rpm for several minutes at room temperature, to obtain the LPF-9 resole composition having viscosity 78000 cP at 25° C.

### Step 9c: Preparation of LFR Rigid Insulation Foams (LFRF-9-13)

Five rigid foams were prepared separately by adding varied amounts of ethoxylated castor oil based surfactant (Lumulse® CO-30), a mixture of blowing agents (75 wt % isopropyl chloride and 25 wt % isopentane) and acid catalyst solution (80 wt % of 70/30 mixture of p-TSA/p-XSA in TEG) to the 50/50 lignin-furfuryl alcohol/resole solution of step 9b. The foamable composition, process conditions and foam properties of these five rigid foams are reported in Table 4.

TABLE 4
LFR foams: composition, process and properties

| | Ex 9 | EX 10 | EX 11 | EX 12 | EX 13 |
|---|---|---|---|---|---|
| Lignin-furfuryl alcohol | 38.07 | 37.41 | 36.75 | 37.26 | 37.04 |
| composition, wt % | | | | | |
| Resole, wt % | 38.07 | 37.41 | 36.75 | 37.26 | 37.04 |
| Surfactant - Lumulse ® | 1.05 | 2.06 | 3.03 | 3.07 | 4.07 |
| CO-30, wt % | | | | | |
| 75/25 IPC/IP, wt % | 6.8 | 6.86 | 6.75 | 7.04 | 6.90 |
| Acid (70% in MEG), wt % | 16.01 | 16.27 | 16.71 | — | — |
| Acid (80% in TEG), wt % | — | — | — | 15.36 | 14.96 |
| Foaming/Curing | 60/70 | 60/70 | 60/70 | 50/70 | 50/70 |
| temperature, C. | | | | | |
| Open-cell, % | 73.45 | 10.87 | 8.92 | 8.62 | 9.08 |
| TC, mW/mK | 35.8 | 26.0 | 24.5 | 23.7 | 25.5 |
| Density, kg/m³ | 37.1 | 39.6 | 41.0 | 40.8 | 40.7 |

The data shown in Table 4 demonstrates that the cell morphology (open or closed-cell) of the rigid LFR foams can be controlled by varying the surfactant amount such as from 1 wt % to 4 wt % in Example 9 to Example 13. The rigid foam of Example 9 had more open-cells (73.45%) prepared from LFR composition having about 1 wt % surfactant as compared to foams of Examples 10-13, prepared from LFR composition having at 2-4 wt % of the same surfactant.

### Comparative Example A: Preparation of Lignin-Resole Foam from Hardwood Lignin without Furfuryl Alcohol

An attempt was made to prepare a foam from a resole prepared by adding the lignin to phenol and formaldehyde in the absence of furfuryl alcohol and maintaining a foamable composition having the same amounts of lignin and water as described in above foam examples but without success.

The preparation was as follows; A lignin/phenol-formaldehyde resole was prepared by reaction of 94.11 g of lignin, L-HW-FP, 282.33 g of phenol with 649.30 g of 37% formaldehyde solution in a 2 L, three-neck flask fitted with an overhead stirrer and a reflux condenser cooled with a recirculation bath. The mixture was stirred at room temperature for 30 minutes to dissolve the solid lignin. The pH was adjusted from 2.31 to 8.87 by the addition of ˜20 g of 50 wt % sodium hydroxide at room temperature. The flask and contents were suspended in an oil bath and the reaction mixture was heated at 1.20° C./min to an internal temperature of 90° C. and maintained at 90° C. for an additional 150 min. This solution was then cooled to room temperature in an ice bath. The solution in the reaction flask was adjusted from 8.08 to pH 6.86 at 23° C. by the addition of concentrated hydrochloric acid. The reaction solution (1.04 kg) was viscous and dark brown in color and was transferred into a 2 L round bottom flask.

To maintain the amount of water in the mixture about 14.5 wt %, the content of the flask was concentrated via rotary evaporation in a bath at 80° C. to 61 wt % (633 g) of the original weight but the mixture was too viscous to pour out of the flask at 80° C. As a result no foam could be made from this composition.

What is claimed is:

1. A lignin-furfuryl alcohol-resole (LFR) composition comprising:
(i) 10-90 wt % of a lignin-furfuryl alcohol composition derived from a lignin, water, and one or more lignin reactive monomers, wherein at least one of the one or more lignin reactive monomers is furfuryl alcohol;
(ii) 10-90 wt % of a phenolic-resole derived from a phenol and a phenol-reactive monomer; and
(iii) optionally 0.1-10 wt % of an organic amine comprising urea, melamine, hexamine, or mixtures thereof, wherein the amounts in wt % are based on the total weight of the LFR composition.

2. The LFR composition of claim 1, wherein the phenol-reactive monomer comprises at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof.

3. The LFR composition of claim 1, wherein the phenol-reactive monomer is formaldehyde.

4. The LFR composition of claim 1, further comprising at least one of an organic anhydride, a surfactant, and a plasticizer.

5. A thermoset polymer derived from the LFR composition of claim 1.

6. A thermoset polymer derived from the LFR composition of claim 1 and at least one of urea-formaldehyde resin, melamine-formaldehyde resin and resorcinol-formaldehyde resin.

7. A lignin-furfuryl alcohol-resole (LFR) foam comprising:
(i) a polymeric phase defining a plurality of open cells and a plurality of closed cells, and
(ii) a gas phase comprising one or more blowing agents disposed in at least a portion of the plurality of closed cells,
wherein the polymeric phase is derived from the lignin-furfuryl alcohol-resole (LFR) composition of claim 1.

8. The LFR foam of claim 7, wherein at least one of the one or more blowing agents comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.

9. The LFR foam of claim 7, wherein at least one of the one or more blowing agents comprises an azeotrope or an azeotrope-like mixture of isopentane and one other blowing agent selected from the group consisting of isopropyl chloride, 1,1,1,4,4,4-hexafluoro-2-butene and 1-chloro-3,3,3,-trifluoropropene.

10. The LFR foam of claim 7, wherein the blowing agent comprises a mixture of isopropyl chloride and isopentane.

11. An article comprising the LFR foam of claim 7.

12. The article of claim 11 comprising a sandwich panel structure, wherein the sandwich panel structure comprises the LFR foam disposed between two similar or dissimilar non-foam materials.

13. A foam formed by foaming and curing a composition at a temperature in the range of 50-100° C., the composition comprising
a. a lignin-furfuryl alcohol composition derived from a lignin, water, and one or more lignin reactive monomers, wherein at least one of the one or more lignin reactive monomers is furfuryl alcohol,
b. a phenolic-resole,
c. a blowing agent,
d. an acid catalyst, and
e. a surfactant.

14. A method of making a lignin-furfuryl alcohol-resole (LFR) foam comprising:
a) forming a lignin-furfuryl alcohol composition from a lignin, water, and one or more lignin reactive monomers, wherein at least one of the one or more lignin reactive monomers is furfuryl alcohol;
b) adding a phenolic-resole to the lignin-furfuryl alcohol composition of step (a) to form a lignin-furfuryl alcohol-resole (LFR) composition, wherein the phenolic-resole is derived from a phenol and a phenol-reactive monomer comprising at least one of formaldehyde, paraformaldehyde, furfuryl alcohol, furfural, glyoxal, acetaldehyde, 5-hydroxymethylfurfural, levulinate esters, sugars, 2,5-furandicarboxylic aldehyde, difurfural (DFF), sorbitol, or mixtures thereof;
c) adding at least one blowing agent to the LFR composition of step (b);
d) adding an aromatic sulfonic acid to the LFR composition of step (b) or (c) to form a foamable-LFR composition;
e) adding a surfactant to at least one of the steps (a), (b), (c) or (d); and
f) foaming and curing the foamable-LFR composition at a temperature in the range of 50-100° C. to form a foam comprising a polymeric phase defining a plurality of open cells and a plurality of closed cells,
wherein the polymeric phase is derived from the lignin-furfuryl alcohol-resole (LFR) composition.

15. The method of claim 14, wherein the aromatic sulfonic acid comprises para-toluenesulphonic acid and xylenesulphonic acid.

16. The method of claim 14, wherein the at least one blowing agent comprises 1,1,1,4,4,4-hexafluoro-2-butene, pentane, isopentane, cyclopentane, petroleum ether, ether, 1-chloro-3,3,3-trifluoropropene, 1,1-dichloro-1-fluoroethane, 2,2-dichloro-1,1,1-trifluoroethane, 1-chloro-1,1-difluoroethane, 1,1,1,2-tetrafluoroethane, 1,1,1,3,3-pentafluoropropane, 1,1,1,3,3-pentafluorobutane, 2-chloropropane (isopropyl chloride), dichlorodifluoromethane, 1,2-dichloro-1,1,2,2-tetrafluoroethane, trichlorotrifluoroethane, trichloromonofluoromethane, or mixtures thereof.

17. The method of claim 14 further comprising disposing the foam between two similar or dissimilar non-foam materials to form a sandwich panel structure.
